(19) United States
(12) Patent Application Publication
(10) Pub. No.: US 2026/0185608 A1
(43) Pub. Date: Jul. 2, 2026

(54) METHOD FOR ACTUATING A PARKING LOCK DEVICE

(71) Applicant: Schaeffler Technologies AG & Co. KG, Herzogenaurach (DE)

(72) Inventors: Carsten Mayer, Lohr a. Main (DE); Bernhard Dix, Rastatt (DE)

(73) Assignee: Schaeffler Technologies AG & Co. KG, Herzogenaurach (DE)

(21) Appl. No.: 18/855,420

(22) PCT Filed: Mar. 14, 2023
(86) PCT No.: PCT/DE2023/100193

§ 371 Date: Oct. 9, 2024

(30) Foreign Application Priority Data
Apr. 11, 2022 (DE) 10 2022 108 693.3

(51) Int. Cl. F16H 63/34; F15B 1/26; F15B 13/04; F16H 63/48

(52) U.S. Cl. CPC F16H 63/3483; F15B 1/26; F15B 13/0401; F16H 63/483; F16H 63/3491

(57) ABSTRACT

A method for actuating a parking lock device having a locking element that can be moved depending on an actuation position of an actuation element in order to set a parking position of a vehicle. A hydraulic device includes a first valve, which can be switched at least between a first valve state and a second valve state in order to change the actuation position via a system pressure. The valve state of the first valve is checked by first initiating a switch between the first and second valve state in a switching step, and then a detection step is carried out in which the system pressure is increased in a pressure increase step, and in an ascertaining step a movement of the actuation element is detected and the valve state of the first valve after the switching step is inferred on the basis of the detected movement.

### CROSS-REFERENCE TO RELATED APPLICATIONS

This application is the U.S. National Phase of PCT Appln. No. PCT/DE2023/100193 filed Mar. 14, 2023, which claims priority to DE 10 2022 108 693.3 filed Apr. 11, 2022, the entire disclosures of which are incorporated by reference herein.

### TECHNICAL FIELD

The disclosure relates to a method for actuating a parking lock device.

### BACKGROUND

DE 10 2019 102 779 A1 describes a method for actuating a parking lock in a vehicle, in which the parking lock is switched to a locking position, in which a parking position of the vehicle is set, via a de-energized holding magnet, which releases a piston of a hydraulic cylinder of a parking lock actuator. A return spring supports the emptying of hydraulic fluid from the hydraulic cylinder into a pump circuit. The parking lock actuation is further supported, in particular at low temperatures, by suctioning the hydraulic fluid from the hydraulic cylinder.

DE 10 2019 123 965 A1 describes a fluid supply device which has two couplings, each hydraulically connected to a supply line by a valve.

### SUMMARY

The object of the present disclosure is to actuate the parking lock device in a more reliable manner. Furthermore, the parking lock device should be implemented in a more cost-effective manner.

At least one of these objects is achieved through a method having the features according to the disclosure. As a result, the parking lock device can be actuated in a quicker and more reliable manner. Furthermore, the parking lock device can be implemented more cost-effectively. The parking position of the vehicle can be set more securely.

The parking lock device can be arranged in a vehicle. The vehicle can be a hybrid or electric vehicle. The vehicle can have an internal combustion engine. Depending on the actuation position, the parking lock device can alternately set a parking position of the vehicle, thereby preventing movement of the vehicle, and release the parking position, thus enabling movement of the vehicle.

The system pressure can be provided by a fluid pump. The fluid pump can further provide a supply fluid flow for cooling, actuating and/or lubricating at least one further consumer, for example an electric motor or a clutch.

The actuation element can be an actuation piston. The actuation piston can be axially displaceable for changing the actuation position.

A first actuation position of the actuation element can correspond to a locking position of the locking element. A second actuation position of the actuation element can correspond to a release position of the locking element. The actuation element can be movably connected to the locking element. The locking element can be a locking pawl. In the locking position, the locking pawl can engage in a form-fitting manner with a parking lock wheel and set it in a rotationally fixed manner. The actuation element can be moved into the first actuation position, supported by a restoring force of a return spring.

The actuation element can be set in the first and/or second actuation position by a securing device. The securing device may comprise a holding magnet. The holding magnet can be actuated electrically. The securing device can have an axially movable securing element that can be moved depending on a securing actuation pressure. The securing element can be a displaceable securing piston. When the securing actuation pressure is applied, the securing element can release a movement of the actuation element. If there is no securing actuation pressure, a return spring element can act on the securing element to secure the actuation position of the actuation element.

In a preferred embodiment of the disclosure, it is advantageous if, in the first valve state, the actuation element is hydraulically connected to a fluid reservoir via a return line and, in the second valve state, the actuation element is hydraulically connected to a system pressure line. The system pressure is preferably present in a system pressure line.

The movement of the actuation element is preferably detected by a displacement sensor. This allows the actuation position to be detected. The displacement sensor can detect an actuation position of the actuation element. The displacement sensor can be arranged on the actuation device.

In a preferred advantageous embodiment of the disclosure, the ascertaining step is carried out temporally overlapping and/or temporally subsequent to the pressure increase step. This means that any movement of the actuation element caused by the increase in pressure can be detected immediately.

In an advantageous embodiment of the disclosure, it is provided that the switch between the first and second valve states of the first valve is dependent on a venting pressure of a second valve built up by the system pressure. The second valve can be actuated electrically. The second valve can be a 4/4-way valve, a 4/3-way valve or a 4/2-way valve.

In a particular embodiment of the disclosure, it is advantageous if the switching step initiates a switch from the second to the first valve state, and in the case of a movement of the actuation element resulting from the pressure increase in the pressure increase step, it is inferred that the second valve state is present and thus that the valve state has been switched erroneously. An erroneous switch can occur, for example, due to a blocked first valve. A switch of the valve state may be impaired by dirt, which can arise in a hydraulic region of the first valve.

If the movement detection step ascertains that the actuation element does not move due to the pressure increase, it can be inferred that the valve state has been switched correctly.

In a preferred embodiment of the disclosure, it is advantageous if, after an erroneous switch of the valve state has been ascertained, an error correction step is carried out in which the system pressure is lowered and increased at least once. This can resolve an unwanted blockage of the first valve. The change in system pressure can cause a change in the venting pressure of the second valve.

The venting pressure can be alternately lowered and increased several times. This can cause pressure surges in the venting pressure, in particular in order to release the stuck first valve.

In a preferred embodiment of the disclosure, it is provided that the detection step is repeated after the error correction step. This allows the effectiveness of the error correction step to be detected.

In a particular embodiment of the disclosure, it is advantageous if an error message is output in the case an erroneous switch is detected by the detection step. This makes it possible to react to the fault of the first valve. For example, the locking element can be given sufficient time to move from a position in which the parking position is released to a position in which the parking position is set.

In a preferred advantageous embodiment of the disclosure, the actuation element is moved into the second valve state by an actuating pressure dependent on the system pressure. In the first valve state, the first valve may be decoupled from the system pressure.

In an advantageous embodiment of the disclosure, it is provided that the actuation element is moved into the second valve state on the basis of the system pressure and thereby moves the locking element so that it cancels the setting of the parking position. This allows the actuation element to be operated directly via the first valve and the system pressure.

Further advantages and advantageous embodiments of the disclosure arise from the description of the figures and the drawings.

### BRIEF DESCRIPTION OF THE DRAWINGS

The disclosure is described in detail below with reference to the drawings. In the drawings:

FIG. 1: shows a parking lock device used for a method in a particular embodiment of the disclosure.

FIG. 2: shows a method for actuating a parking lock device in a particular embodiment of the disclosure.

FIG. 3: shows a timing diagram of a parking lock device where there is no malfunction of the first valve.

FIG. 4: shows a timing diagram of a parking lock device where there is a malfunction of the first valve.

FIGS. 5 and 6: shows a timing diagram of the parking lock device when carrying out a respective method in a particular embodiment of the disclosure.

### DETAILED DESCRIPTION

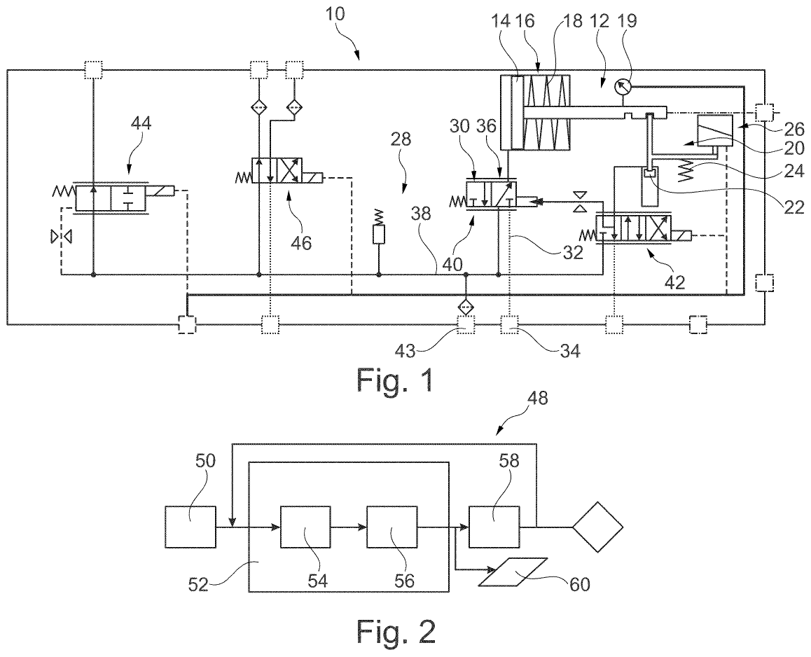

FIG. 1 shows a parking lock device used for a method in a particular embodiment of the disclosure. The parking lock device 10 has a locking element that can be moved depending on an actuation position of an actuation element 12 in order to set a parking position of a vehicle. The actuation element is designed as an actuation piston 14, which is axially movable for changing the actuation position. In a first actuation position 16, as shown here, the locking element is designed to set the parking position, and in a second actuation position, the locking element releases the parking position.

A switch from the first to a second actuation position 16 is effected by an actuating pressure acting on the actuation element 12 against the restoring force of a return spring 18. A reverse movement from the second actuation position to the first actuation position 16 is effected by the restoring force of the return spring 18 when the actuating pressure on the actuation element 12 is reduced or not present. A movement of the actuation element 12, and thus the actuation position of the actuation element 12, is detected by a displacement sensor 19.

A switch of the actuation position requires the actuation element 12 to be released. A securing device 20 designed to secure the actuation position of the actuation element 12 comprises a displaceable securing piston 22 which can be displaced via a securing actuation pressure against the restoring force of a further return spring element 24. An electrically activatable linear solenoid 26 ensures redundancy in the securing facility.

The parking lock device 10 has a hydraulic device 28 comprising a first valve 40 that can be switched between a first valve state 30, in which the actuation element 12 is hydraulically connected to a fluid reservoir 34 via a return line 32, and a second valve state 36, in which the actuation element 12 is hydraulically connected to a system pressure line 38. The first valve 40 is actuated via a venting pressure of a second valve 42. The first valve 40 is designed as a 3/2-way valve and the second valve 42 is designed as a 4/3-way valve.

The system pressure in the system pressure line 38 is provided by a fluid pump 43. A system pressure valve 44 is connected to the system pressure line 38, which supplies additional consumers, for example for cooling, lubrication and/or actuation purposes. A clutch valve 46 is also connected to the system pressure line 38 and causes the actuation of a clutch depending on the system pressure and a valve position of the clutch valve 46.

A switch of the valve state of the first valve 40 may fail if the first valve 40 is stuck. In this case, in particular, a switch from the second to the first actuation position 16 cannot be carried out, or can be carried out with a delay, when the first valve 40 is stuck in the second valve state 36, since the system pressure acts as an actuating pressure on the actuation element 12 against the restoring force of the return spring 18 which sets the first actuation position 16.

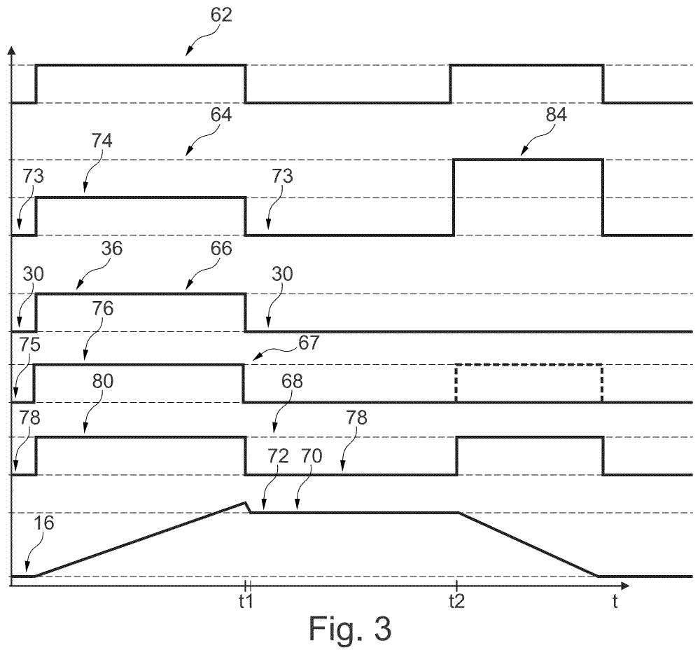

FIG. 2 shows a method for actuating a parking lock device in a particular embodiment of the disclosure. The method 48 for actuating the parking lock device is used, for example, when switching from the first to the second actuation position. When the second valve state is switched, the actuation element is deflected from the first to the second actuation position via an actuating pressure dependent on the system pressure.

When the second actuation position is reached, a switch from the second to the first valve state is initiated in a switching step 50. Subsequently, a detection step 52 is carried out, which comprises a pressure increase step 54, in which the system pressure in the system pressure line is increased, and an ascertaining step 56, in which a movement of the actuation element is detected. Depending on the detected movement of the actuation element, the valve state of the first valve after the switching step 50 is inferred.

The ascertaining step 56 is carried out temporally subsequent to the pressure increase step 54, but can also temporally overlap the pressure increase step 54.

If the actuation element moves due to the pressure increase in the pressure increase step 54, it is inferred that the second valve state is present and thus that an erroneous switch has taken place. The increase in the system pressure in the system pressure line causes an increase in the actuating pressure and this causes a movement of the actuation element, preferably within the movement play provided by the securing device. If this association between the system pressure increase and the movement of the actuation element is present, the first valve is still in the second valve state, in which the actuation element is hydraulically connected to the system pressure line.

If an erroneous switch is detected, an error correction step 58 can preferably be carried out in which the venting pressure is lowered and increased above the system pressure at least once. Subsequently, the detection step 52 is preferably repeated. An erroneous switch detected by the detection step 52 can trigger an error message 60. The error message 60 may be issued if the erroneous switch is detected before and/or after the error correction step 58.

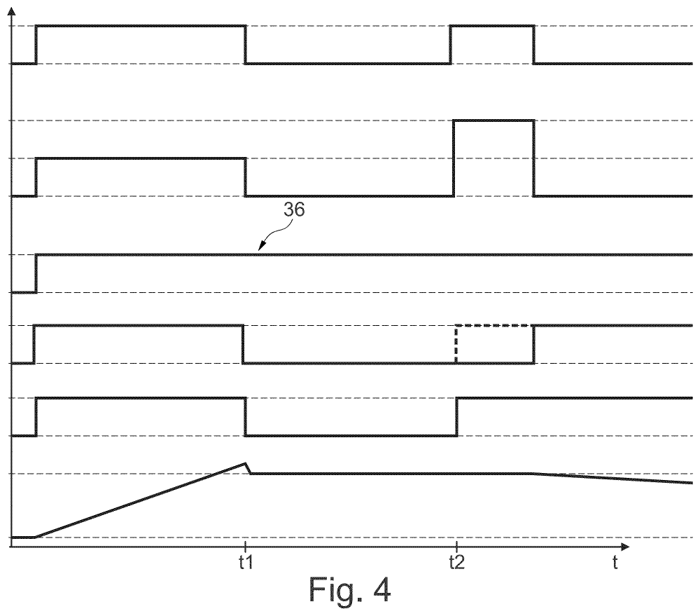

FIG. 3 shows a timing diagram of a parking lock device where there is no malfunction of the first valve. The timing diagram shows the time course of the valve state of the system pressure valve 62, the valve state of the second valve 64, the valve state of the first valve 66, the excitation 67 of the linear solenoid, the securing position 68 of the securing element and the actuation position 70 of the actuation element.

When switching from the first actuation position 16 of the actuation element, via which the locking element sets a parking position of the vehicle, to a second actuation position 72, the system pressure valve is closed. The second valve is switched from a first valve state 73 to a second valve state 74, whereby the venting pressure is increased above the system pressure and the first valve 40 is switched from the first valve state 30 to the second valve state 36. The linear solenoid is switched from a de-energized operation 75 to an electrically active operation 76 and the securing device is moved from a locking position 78 to an unlocked position 80.

After the second actuation position 72 has been reached at time t1, the system pressure valve is opened, the second valve is switched to the first valve state 73 and the first valve is switched to the first valve state 30. The linear solenoid is de-energized and the securing element is in the locking position 78.

The switch from the second actuation position 72 to the first actuation position 70, i.e. the engagement of the parking lock device, starting at the time t2 takes place analogously to the previously described disengagement of the parking lock device, except that the second valve assumes a third valve state 84 and the first valve remains in the first valve state 30. The linear solenoid can optionally be operated electrically.

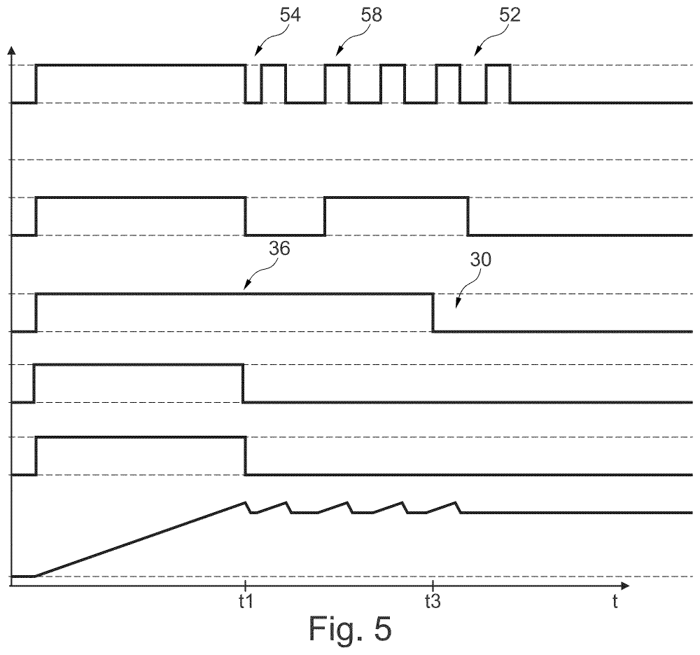

FIG. 4 shows a timing diagram of a parking lock device where there is a malfunction of the first valve. The timing diagram in FIG. 4 is identical to that in FIG. 3 except for the following important differences. After completion of the switch to the second actuation position 72 at the time t1, the first valve unintentionally remains in the second valve state 36; the switch of the valve state of the first valve is thus erroneous.

As a result, when the parking lock device is subsequently engaged starting at time t2, in which the switch is to be made from the second actuation position 72 to the first actuation position 70, the movement of the actuation element to the first actuation position 70 is slow, since the first valve has switched to the second valve state 36, in which the actuating pressure is built up via the system pressure and the restoring force of the return spring element offers a greater counterforce, which is only reduced gradually via the system pressure line.

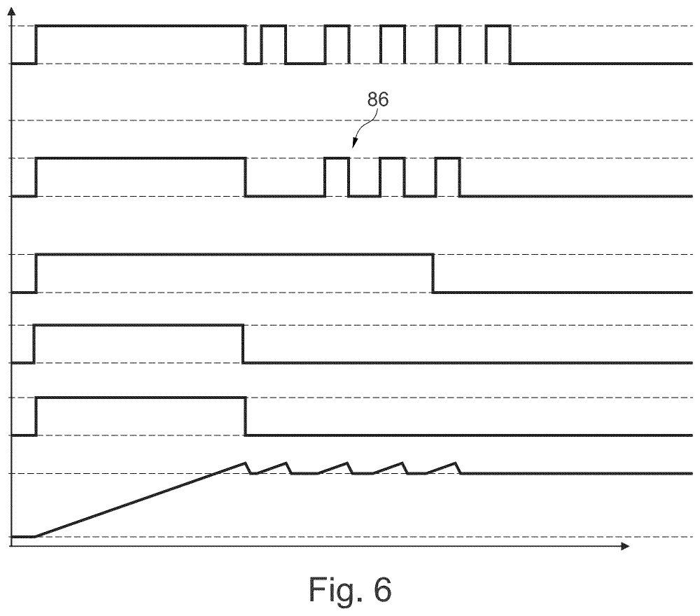

FIGS. 5 and 6 show a timing diagram of the parking lock device when carrying out a respective method in a particular embodiment of the disclosure. The timing diagram in FIG. 5 is identical to that of FIG. 4 except for the following important differences. After completion of the switch from the first actuation position 70 to the second actuation position 72 at the time t1 and the first valve is stuck and maintains the second valve state 36 despite the switch attempt, the detection step is carried out with the pressure increase step 54, via which the system pressure is increased again by closing the system pressure valve. The increase in the system pressure causes an increase in the venting pressure and thus a movement of the actuation element. Depending on the movement detection, the present valve state of the first valve, here the second valve state 36, is inferred.

In a subsequent error correction step 58, the system pressure is alternately lowered and increased several times and the venting pressure is increased accordingly via the switched second valve state 36 of the second valve. The first valve is thereby released and assumes the first valve state 30 at time t3. In a final detection step 52, it is ascertained that there is no movement of the actuation element despite the increase in system pressure and thus the first valve has assumed the first valve state 30 as desired.

FIG. 6 shows a timing diagram identical to that in FIG. 5, except for the following differences. In order to exclude a malfunction of the second valve, which causes the second valve to fail to change the valve state, the second valve can also be excited by electrical impulses 86 in order to eliminate a possible blockage of the second valve.

List of reference signs

| | |
|---|---|
| 10 | Parking lock device |
| 12 | Actuation element |
| 14 | Actuation piston |
| 16 | First actuation position |
| 18 | Return spring |
| 19 | Displacement sensor |
| 20 | Securing device |
| 22 | Securing piston |
| 24 | Further return spring element |
| 26 | Linear solenoid |
| 28 | Hydraulic device |
| 30 | First valve state |
| 32 | Return line |
| 34 | Fluid reservoir |
| 36 | Second valve state |
| 38 | System pressure line |
| 40 | First valve |
| 42 | Second valve |
| 43 | Fluid pump |
| 44 | System pressure valve |
| 46 | Clutch valve |
| 48 | Process |
| 50 | Switching step |
| 52 | Detection step |
| 54 | Pressure increase step |
| 56 | Ascertaining step |
| 58 | Error correction step |
| 60 | Error message |
| 62 | Valve state of the system pressure valve |
| 64 | Valve state of the second valve |
| 66 | Valve state of the first valve |
| 67 | Excitation |
| 68 | Securing position |
| 70 | Actuation position |
| 72 | Second actuation position |
| 73 | First valve state |
| 74 | Second valve state |
| 75 | De-energized operation |
| 76 | Active operation |
| 78 | Locking position |
| 80 | Unlocked position |
| 82 | First valve state |
| 84 | Third valve state |
| 86 | Electrical impulses |

1. A method for actuating a parking lock device comprising:
moving a locking element depending on an actuation position of an actuation element in order to set a parking position of a vehicle,
switching a first valve of a hydraulic device at least between a first valve state and a second valve state in order to change the actuation position via a system pressure,
wherein the valve state of the first valve is checked by first initiating a switch between the first and second valve state in a switching step, and then a detection step is carried out in which the system pressure is increased in a pressure increase step, and in an ascertaining step a movement of the actuation element is detected and the valve state of the first valve after the switching step is inferred on the basis of the detected movement.

2. The method according to claim 1, wherein, in the first valve state, the actuation element is hydraulically connected to a fluid reservoir via a return line, and in the second valve state, the actuation element is hydraulically connected to a system pressure line.

3. The method according to claim 1, wherein the ascertaining step is carried out temporally overlapping and/or temporally subsequent to the pressure increase step.

4. The method according to claim 1, wherein the switch between the first and second valve states of the first valve is dependent on a venting pressure of a second valve built up by the system pressure.

5. The method according to claim 1, wherein the switching step initiates a switch from the second to the first valve state, and in the case of a movement of the actuation element resulting from the pressure increase in the pressure increase step, it is inferred that the second valve state is present and thus that the valve state has been switched erroneously.

6. The method according to claim 5, wherein after an erroneous switch of the valve state has been ascertained, an error correction step is carried out in which the system pressure is lowered and increased at least once.

7. The method according to claim 6, wherein the detection step is repeated after the error correction step.

8. The method according to claim 5, wherein an error message is output in the event that an erroneous switch of the valve state is detected by the detection step.

9. The method according to claim 1, wherein the actuation element is moved into the second valve state by an actuating pressure dependent on the system pressure.

10. The method according to claim 1, wherein the actuation element is moved into the second valve state on the basis of the system pressure and thereby moves the locking element so that said locking element cancels a determination of the parking position.
